(19) United States
(12) Patent Application Publication
(10) Pub. No.: US 2020/0349790 A1
(43) Pub. Date: Nov. 5, 2020

(54) LOTTERY NUMBER GENERATING ASSEMBLY

(71) Applicants: Jeffery Sepulveda, Devine, TX (US); Kimberly Parton, Devine, TX (US)

(72) Inventors: Jeffery Sepulveda, Devine, TX (US); Kimberly Parton, Devine, TX (US)

(21) Appl. No.: 16/399,033

(22) Filed: Apr. 30, 2019

(51) Int. Cl. G07C 15/00; G06F 7/58

(52) U.S. Cl. CPC G07C 15/006; G06F 7/588; G07C 15/001

(57) ABSTRACT

A lottery number generating assembly includes a housing, a control circuit positioned within the housing and a random number generator positioned within the housing. The random number generator randomly selects five numbers each ranging between 1 and 99 when the random number generator is turned on to randomly select numbers for playing power ball lottery or mega ball lottery. A plurality of touch screens is each coupled to the housing and each of the touch screens is electrically coupled to the control circuit. Each of the touch screens displays indicia comprising a respective one of the randomly selected numbers to display the randomly selected numbers for a user to play the power ball lottery or the mega ball lottery.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to number generating devices and more particularly pertains to a new number generating device for randomly selecting power ball numbers and mega ball numbers.

### BRIEF SUMMARY OF THE INVENTION

An embodiment of the disclosure meets the needs presented above by generally comprising a housing, a control circuit positioned within the housing and a random number generator positioned within the housing. The random number generator randomly selects five numbers each ranging between 1 and 99 when the random number generator is turned on to randomly select numbers for playing power ball lottery or mega ball lottery. A plurality of touch screens is each coupled to the housing and each of the touch screens is electrically coupled to the control circuit. Each of the touch screens displays indicia comprising a respective one of the randomly selected numbers to display the randomly selected numbers for a user to play the power ball lottery or the mega ball lottery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a lottery number generating assembly according to an embodiment of the disclosure.

FIG. 2 is a back phantom view of an embodiment of the disclosure.

FIG. 3 is a top view of an embodiment of the disclosure.

FIG. 4 is a schematic view of an embodiment of the disclosure.

### DETAILED DESCRIPTION OF THE INVENTION

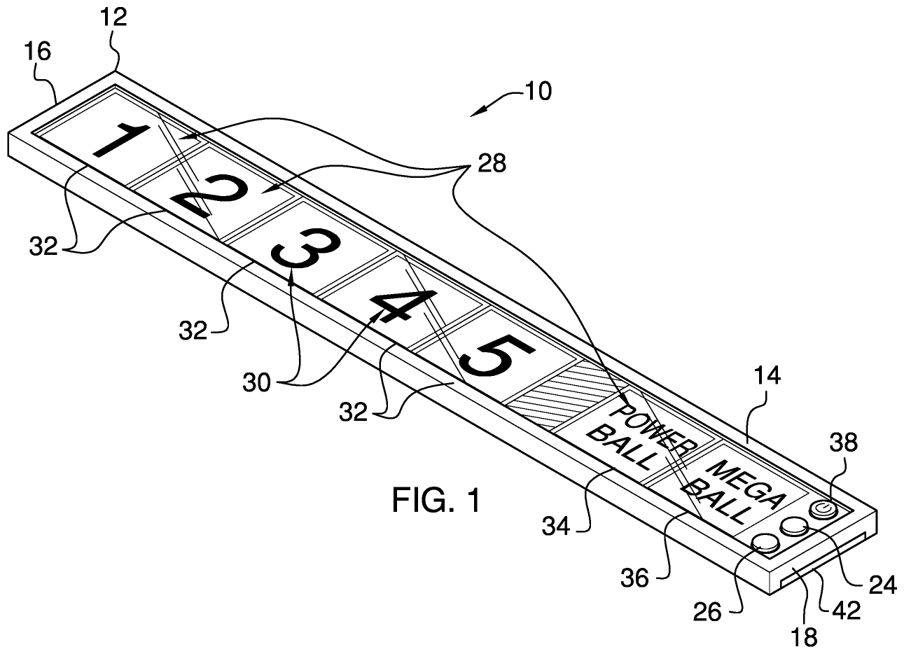

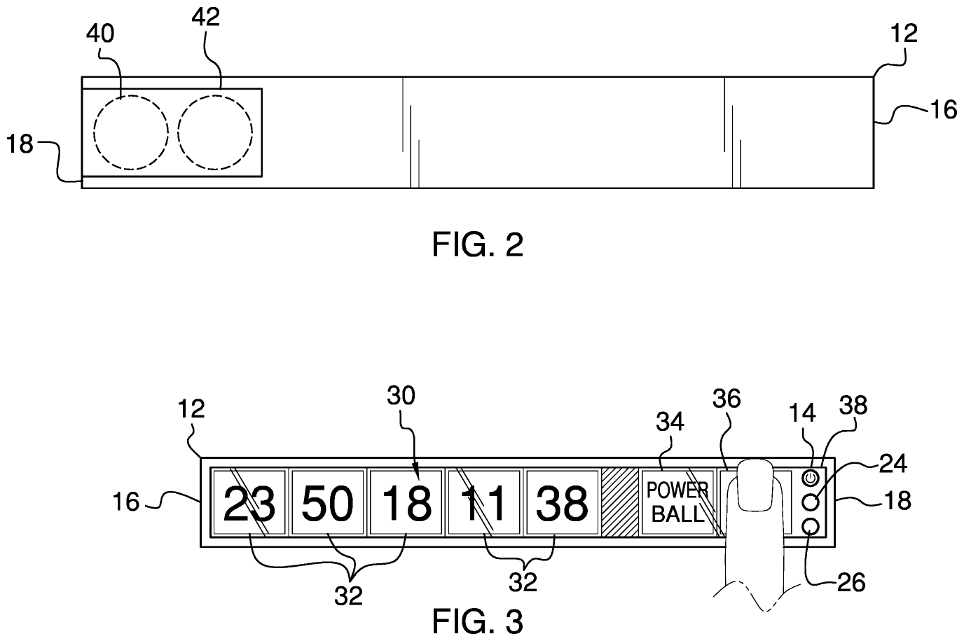

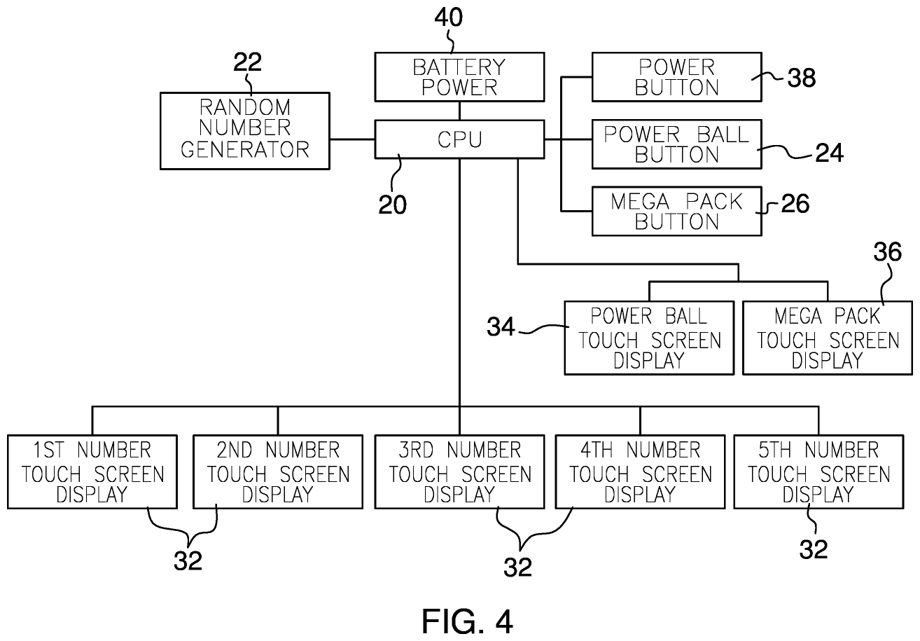

With reference now to the drawings, and in particular to FIGS. 1 through 4 thereof, a new number generating device embodying the principles and concepts of an embodiment of the disclosure and generally designated by the reference numeral 10 will be described.

As best illustrated in FIGS. 1 through 4, the lottery number generating assembly 10 generally comprises a housing 12 that is longitudinally elongated. The housing 12 has a top side 14, a first lateral side 16 and a second lateral side 18. Additionally, the housing 12 may have a length of approximately 10.0 inches and a width of approximately 2.0 inches. A control circuit 20 is positioned within the housing 12 and the control circuit 20 receives a power ball input, a mega ball input and a reselect input. Additionally, the control circuit 20 may include an electronic memory for storing data.

A random number generator 22 is positioned within the housing 12 and the random number generator 22 randomly selects five numbers each ranging between 1 and 99 when the random number generator 22 is turned on. Thus, the random number generator 22 can randomly select numbers for playing power ball lottery or mega ball lottery. The random number generator 22 is electrically coupled to the control circuit 20. The random number generator 22 is turned on to select five power ball numbers when the control circuit 20 receives the power ball input. The random number generator 22 is turned on to select five mega ball numbers when the control circuit 20 receives the mega ball input. Moreover, the random number generator 22 is turned on to select a single number when the control circuit 20 receives the reselect input. The random number generator 22 may be an electronic random number generator or the like.

A power ball button 24 is movably coupled to the housing 12, the power ball button 24 is electrically coupled to the control circuit 20 and the control circuit 20 receives the power ball input when the power ball button 24 is depressed. A mega ball button 26 is movably coupled to the housing 12, the mega ball button 26 is electrically coupled to the control circuit 20 and the control circuit 20 receives the mega ball input when the mega ball button 26 is depressed. A plurality of touch screens 28 is each coupled to the housing 12 and each of the touch screens 28 is electrically coupled to the control circuit 20. Each of the touch screens 28 displays indicia 30 comprising a respective one of the randomly selected numbers. Thus, the plurality of touch screens 28 displays the randomly selected numbers for a user to play the power ball lottery or the mega ball lottery.

Each of the touch screens 28 is positioned on the top side 14 of the housing 12 and the touch screens 28 are distributed between the first lateral side 16 and the second lateral side 18 of the housing 12. Each of the touch screens 28 is electrically coupled to the control circuit 20 and each of the touch screens may comprise an LED touch screen or the like. Additionally, the plurality of touch screens 28 includes a set of number screens 32, a power ball screen 34 and a mega ball screen 36. The set of number screens 32 displays the five power ball numbers when the power ball screen 34 is touched and the set of number screens 32 displays the five mega ball numbers when the mega ball screen 36 is touched. The five power ball numbers and the five mega ball numbers may be stored in the electronic memory when the random number generator 22 selects the five power ball numbers and the five mega ball numbers.

The control circuit 20 receives the reselect input when any of the number screens 32 is touched for randomly selecting a different number on the number screen 32 that has been touched. In this way the user can reselect any of the randomly selected numbers if the user does not like one of the randomly selected numbers. Thus, the user has complete control over which numbers the user might like to play for the power ball lottery or the mega ball lottery. A power button 38 is movably coupled to the housing 12 and the power button 38 is electrically coupled to the control circuit 20 for turning the control circuit 20 on and off. A power supply 40 is removably positioned in the housing 12, the power supply 40 is electrically coupled to the control circuit 20 and the power supply 40 comprises at least one battery. A battery slide 42 may be slidably coupled to the housing 12 and the at least one battery may be positioned on the battery slide 42. Additionally, the battery slide 42 may be slid outwardly from the housing 12 for replacing the at least one battery.

In use, the power button 38 is depressed to turn on the control circuit 20 and the power ball button 24 is depressed to randomly select the five power ball numbers. Each of the number screens 32 displays a respective one the five power ball numbers thereby facilitating the user to fill out a power ball slip with the five power ball numbers. The mega ball button 26 is depressed to randomly select the five mega ball numbers. Each of the number screens 32 displays the power ball numbers when the power ball screen 34 is touched, and each of the number screens 32 displays the mega ball numbers when the mega ball screen 36 is touched. Any of the number screens 32 can be touched to randomly generate a new number on the number screen 32 that has been touched. In this way the user can reselect any of the power ball number or the mega ball numbers until the user is satisfied with the numbers that have been selected for subsequently filling out a lottery slip with the selected numbers.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lottery number generating assembly being configured to randomly select and subsequently display a plurality of numbers for a lottery, said assembly comprising:
a housing being longitudinally elongated;
a control circuit being positioned within said housing;
a random number generator being positioned within said housing, said random number generator randomly selecting five numbers each ranging between 1 and 99 when said random number generator is turned on wherein said random number generator is configured to randomly select numbers for playing power ball lottery or mega ball lottery; and
a plurality of touch screens, each of said touch screens being coupled to said housing, each of said touch screens being electrically coupled to said control circuit, each of said touch screens displaying indicia comprising a respective one of the randomly selected numbers wherein said plurality of touch screens is configured to display the randomly selected numbers for a user to play the power ball lottery or the mega ball lottery.

2. The assembly according to claim 1, wherein:
said control circuit receives a power ball input, a mega ball input and a reselect input;
said random number generator is electrically coupled to said control circuit, said random number generator being turned on to select five power ball numbers when said control circuit receives said power ball input;
said random number generator is turned on to select five mega ball numbers when said control circuit receives said mega ball input; and
said random number generator is turned on to select a single number when said control circuit receives said reselect input.

3. The assembly according to claim 2, further comprising a power ball button being movably coupled to said housing, said power ball button being electrically coupled to said control circuit, said control circuit receiving said power ball input when said power ball button is depressed.

4. The assembly according to claim 2, further comprising a mega ball button being movably coupled to said housing, said mega ball button being electrically coupled to said control circuit, said control circuit receiving said mega ball input when said mega ball button is depressed.

5. The assembly according to claim 2, wherein:
said housing has a top side, a first lateral side and a second lateral side; and
each of said touch screens is positioned on said top side of said housing, said touch screens being distributed between said first lateral side and said second lateral side of said housing, each of said touch screens being electrically coupled to said control circuit, said plurality of touch screens including a set of number screens, a power ball screen and a mega ball screen.

6. The assembly according to claim 5, wherein:
said set of number screens displays the five numbers selected for the power ball lottery when said power ball screen is touched; and
said set of number screens displays the five numbers selected for the mega ball lottery when said mega ball screen is touched.

7. The assembly according to claim 6, wherein said control circuit receives said reselect input when any of said number screens is touched for randomly selecting a different number on said number screen that has been touched.

8. The assembly according to claim 1, further comprising:
a power button being movably coupled to said housing, said power button being electrically coupled to said control circuit for turning said control circuit on and off; and
a power supply being removably positioned in said housing, said power supply being electrically coupled to said control circuit, said power supply comprising at least one battery.

9. A lottery number generating assembly being configured to randomly select and subsequently display a plurality of numbers for a lottery, said assembly comprising:
a housing being longitudinally elongated, said housing having a top side, a first lateral side and a second lateral side;
a control circuit being positioned within said housing, said control circuit receiving a power ball input, a mega ball input and a reselect input;
a random number generator being positioned within said housing, said random number generator randomly selecting five numbers each ranging between 1 and 99 when said random number generator is turned on wherein said random number generator is configured to randomly select numbers for playing power ball lottery or mega ball lottery, said random number generator being electrically coupled to said control circuit, said random number generator being turned on to select five power ball numbers when said control circuit receives said power ball input, said random number generator being turned on to select five mega ball numbers when said control circuit receives said mega ball input, said random number generator being turned on to select a single number when said control circuit receives said reselect input;
a power ball button being movably coupled to said housing, said power ball button being electrically coupled to said control circuit, said control circuit receiving said power ball input when said power ball button is depressed;
a mega ball button being movably coupled to said housing, said mega ball button being electrically coupled to said control circuit, said control circuit receiving said mega ball input when said mega ball button is depressed;
a plurality of touch screens, each of said touch screens being coupled to said housing, each of said touch screens being electrically coupled to said control circuit, each of said touch screens displaying indicia comprising a respective one of the randomly selected numbers wherein said plurality of touch screens is configured to display the randomly selected numbers for a user to play the power ball lottery or the mega ball lottery, each of said touch screens being positioned on said top side of said housing, said touch screens being distributed between said first lateral side and said second lateral side of said housing, each of said touch screens being electrically coupled to said control circuit, said plurality of touch screens including a set of number screens, a power ball screen and a mega ball screen, said set of number screens displaying the five power ball numbers when said power ball screen is touched, said set of number screens displaying the five numbers mega ball numbers when said mega ball screen is touched, said control circuit receiving said reselect input when any of said number screens is touched for randomly selecting a different number on said number screen that has been touched;
a power button being movably coupled to said housing, said power button being electrically coupled to said control circuit for turning said control circuit on and off; and
a power supply being removably positioned in said housing, said power supply being electrically coupled to said control circuit, said power supply comprising at least one battery.
